(19) United States
(12) Patent Application Publication
(10) Pub. No.: US 2008/0129789 A1
(43) Pub. Date: Jun. 5, 2008

(54) FLEXIBLE ELECTROTHERMAL TAPE AND METHOD FOR MANUFACTURING THE SAME

(76) Inventor: Steven Yue, Taipei (TW)

Correspondence Address: PERMAN & GREEN, 425 POST ROAD, FAIRFIELD, CT, 06824, US

(21) Appl. No.: 11/946,355

(22) Filed: Nov. 28, 2007

(30) Foreign Application Priority Data
Dec. 4, 2006 (CN) 200610163755.9

(51) Int. Cl. B41J 2/05

(52) U.S. Cl. 347/56

(57) ABSTRACT

A flexible electrothermal tape includes first and second conductive wires each having an end portion connected electrically to a corresponding one of opposite ends of an electrothermal wire. A flexible film member encloses sealingly the electrothermal wire and the end portions of the first and second conductive wires. The film member has a pair of film parts overlapping each other such that the electrothermal wire and the end portions of the first and second conductive wires are disposed between the film parts. A method for manufacturing the flexible electrothermal tape is also disclosed.

### CROSS-REFERENCE TO RELATED APPLICATION

This application claims priority of Chinese Application No. 200610163755.9, filed on Dec. 4, 2006.

### BACKGROUND OF THE INVENTION

1. Field of the Invention

The invention relates to a flexible electrothermal tape and method for manufacturing the same, more particularly to a flexible electrothermal tape and method for manufacturing the same that can ensure a superior sealing effect.

2. Description of the Related Art

In conventional electrothermal devices, an electrothermal wire having a high impedance is used for generating heat. The electrothermal wire is covered by an insulating sleeve for waterproofing purposes. Opposite ends of the electrothermal wire are exposed from the insulating sleeve to be respectively coupled to two conductive wires, and glue is applied to the end portions of the electrothermal wire for sealing the whole electrothermal wire.

However, in such a configuration, the glue applied to the end portions of the electrothermal wire is easily deteriorated as a result of over-heating such that the electrothermal wire cannot be sealed effectively.

### SUMMARY OF THE INVENTION

Therefore, the object of the present invention is to provide a flexible electrothermal tape and method for manufacturing the same that can ensure a superior sealing effect.

According to one aspect of the present invention, a flexible electrothermal tape comprises:

an electrothermal wire having opposite ends;

first and second conductive wires, each of which has an end portion connected electrically to a corresponding one of the opposite ends of the electrothermal wire; and

a flexible film member enclosing sealingly the electrothermal wire and the end portions of the conductive wires, the film member having a pair of film parts overlapping each other such that the electrothermal wire and the end portions of the first and second conductive wires are disposed between the film parts.

According to another aspect of the present invention, there is provided a method of fabricating a flexible electrothermal tape. The method comprises the steps of:

a) placing an electrothermal wire coupled electrically to and disposed between first and second conductive wires and enclosed by a flexible film member in a mold cavity of a lower mold, the electrothermal wire having opposite ends, each of which is connected electrically to an end portion of a corresponding one of the first and second conductive wires, the film member having a pair of film parts overlapping each other such that the electrothermal wire and the end portions of the first and second conductive wires are disposed between the film parts;

b) disposing an upper mold complementary to the lower mold on the lower mold such that each of the film parts has a peripheral portion clamped between the lower and upper molds, and such that the upper mold cooperates with the lower mold so as to define an air-extracting channel therebetween;

c) heat-sealing the peripheral portions of the film parts of the film member such that an inner space is formed between the film parts, an opening being formed between the peripheral portions of the film parts and being in spatial communication with the air-extracting channel in an assembly of the lower and upper molds;

d) extracting air from the inner space between the film parts via the opening and the air-extracting channel, and heat-sealing the opening so that the electrothermal wire interconnecting electrically the first and second conductive wires cooperates with the film member to constitute the flexible electrothermal tape; and

e) removing the flexible electrothermal tape from the upper and lower molds.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view showing the first preferred embodiment of a flexible electrothermal tape according to the present invention;

FIG. 2 is a schematic sectional view showing the first preferred embodiment;

FIG. 3 is a flow chart of a method for manufacturing the first preferred embodiment;

FIG. 4 is a schematic top view illustrating the first preferred embodiment at a stage of manufacture of step (a) of FIG. 3;

FIG. 5 is a schematic side view illustrating the first preferred embodiment at a stage of manufacture of step (b) of FIG. 3;

FIGS. 6 and 7 are schematic sectional views illustrating the first preferred embodiment respectively at stages of manufacture of steps (c) and (d) of FIG. 3;

FIG. 8 is a schematic sectional view showing the second preferred embodiment of a flexible electrothermal tape according to the present invention;

FIG. 9 is a schematic sectional view illustrating the second preferred embodiment at a stage of manufacture of step (d) of FIG. 3;

FIG. 10 is a schematic view showing the third preferred embodiment of a flexible electrothermal tape according to the present invention;

FIG. 11 is a schematic view showing the fourth preferred embodiment of s flexible electrothermal tape according to the present invention; and

FIGS. 12 to 16 are schematic views illustrating various applications of the first preferred embodiment.

### DETAILED DESCRIPTION OF THE PREFERRED EMBODIMENTS

Before the present invention is described in greater detail, it should be noted that like elements are denoted by the same reference numerals throughout the disclosure.

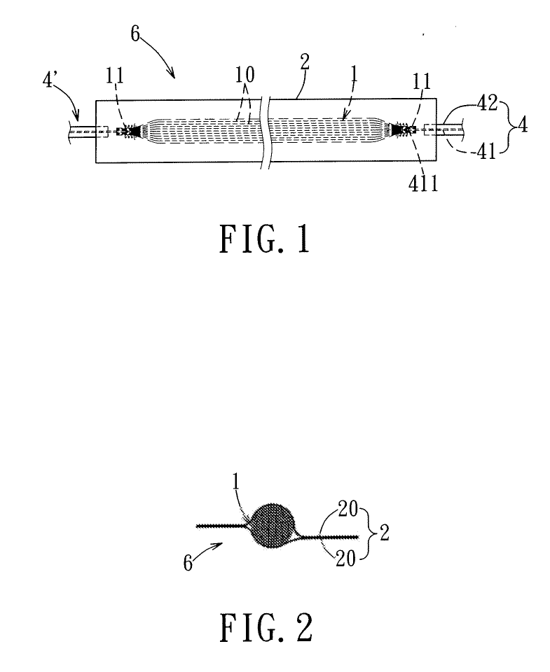

Referring to FIGS. 1 and 2, the first preferred embodiment of a flexible electrothermal tape according to the present invention is shown to include an electrothermal wire 1, first and second conductive wires 4, 4′, and a flexible film member 2.

In this embodiment, the electrothermal wire 1 has opposite ends 11, and includes a plurality of carbon fiber bundles 10. Each of the carbon fiber bundles 10 has opposite first and second ends.

Each of the first and second conductive wires 4, 4′ has an end portion connected electrically to a corresponding one of the opposite ends 11 of the electrothermal wire 1. In this embodiment, the first and second ends of the carbon fiber bundles 10 are bundled respectively by the end portions of the first and second conductive wires 4, 4′. Furthermore, the first and second ends of the carbon fiber bundles 10 of the electrothermal wire 1 are soldered to the end portions of the first and second conductive wires 4, 4′. Each of the first and second conductive wires 4, 4′ includes a metal wire 41 having a bundling end 411 for bundling corresponding ones of the first and second ends of the carbon fiber bundles 10 of the electrothermal wire 1, and an insulating sleeve 42 sleeved on the metal wire 41 such that the bundling end 411 of the metal wire 41 extends outwardly of the insulating sleeve 42. As such, for each of the first and second conductive wires 4, 4′, the bundling end 411 of the corresponding metal wire 41 and a part of the corresponding insulating sleeve 42 constitute the end portion.

The film member 2 encloses sealingly the electrothermal wire 1 and the end portions of the first and second conductive wires 4, 4′. The film member 2 has a pair of film parts 20 overlapping each other such that the electrothermal wire 1 and the end portions of the first and second conductive wires 4, 4′ are disposed between the film parts 20. The film parts 20 are interconnected and a vacuum is created therebetween. For each of the first and second conductive wires 4, 4′, the bundling end 411 of the corresponding metal wire 41 and the part of the corresponding insulating sleeve 42 are heat-sealed between the film parts 20. In this embodiment, the film member 2 is non-unitary, includes two film bodies 20 that serve as the film parts 20, and is made of a water proof material that includes polyimide, such as KAPTON®, which can be used within a temperature range from −269° C. to 400° C., such that the waterproof material has a work temperature of about 250° C. and can be variously shaped.

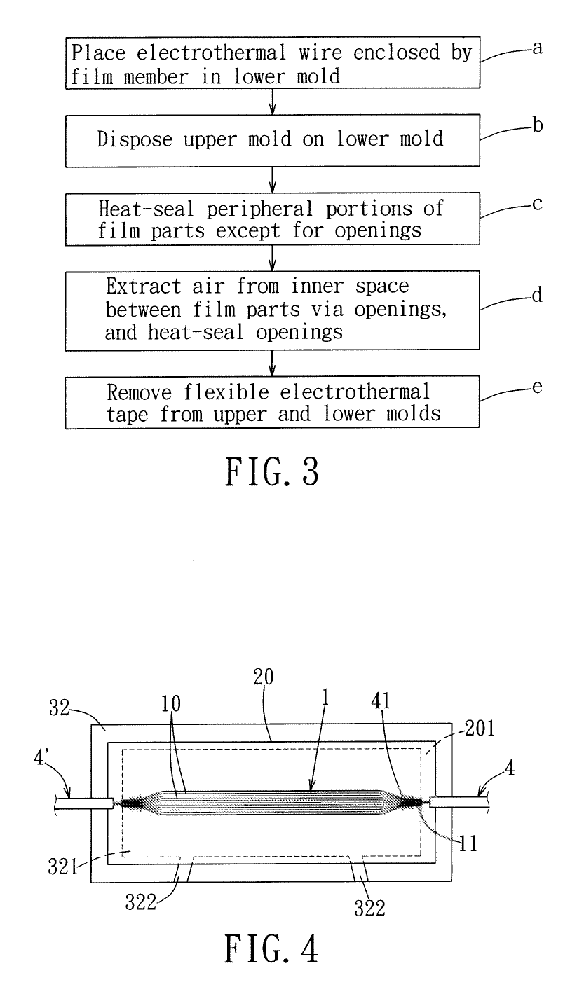

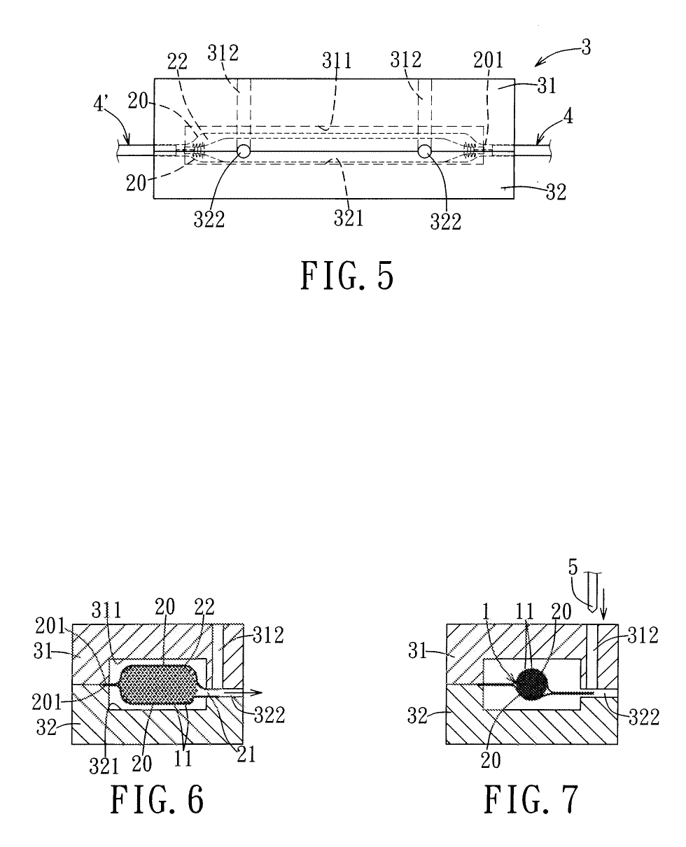

FIG. 3 illustrates steps involved in a method for manufacturing the first preferred embodiment of the flexible electrothermal tape 6.

In step (a), the electrothermal wire 1 coupled electrically to and disposed between the first and second conductive wires 4, 4′ and enclosed by the film member 2 is placed in a mold cavity 321 of a lower mold 32, as shown in FIG. 4.

In step (b), an upper mold 31 complementary to the lower mold 32 is disposed on the lower mold 32 such that each of the film parts 20 has a peripheral portion 201 clamped between the lower and upper molds 32, 31, and such that the upper mold 31 cooperates with the lower mold 32 so as to define two air-extracting channels 322 therebetween, as best shown in FIG. 6. In this embodiment, the upper mold 31 is formed with two heat-seal channels 312 (only one is shown in FIG. 6) that are respectively in spatial communication with the air-extracting channels 322 in an assembly of the lower and upper molds 32, 31, and that permit insertion of a heat-sealing device 5 (see FIG. 7) thereinto.

In step (c), the peripheral portions 201 of the film parts 20 of the film member 2 are heat-sealed such that an inner space 22 (see FIG. 6) is formed between the film parts 20. It is noted that, due to the presence of the air-extracting channels 322 in the assembly of the lower and upper molds 32, 31, two openings 21 (only one is shown in FIG. 6) are formed between the peripheral portions 201 of the film parts 20, and are respectively in spatial communication with the air-extracting channels 322 in the assembly of the lower and upper molds 32, 31.

In step (d), as shown in FIG. 7, air is extracted from the inner space 22 between the film parts 20 via the openings 21 and the air-extracting channels 322. Thereafter, the openings 21 are heat-sealed such that a vacuum is created between the film parts 20. As such, the electrothermal wire 1 interconnecting electrically the first and second conductive wires 4, 4′ cooperates with the film 2 to constitute the flexible electrothermal tape 6.

In step (e), the flexible electrothermal tape 6 is removed from the lower and upper molds 32, 31.

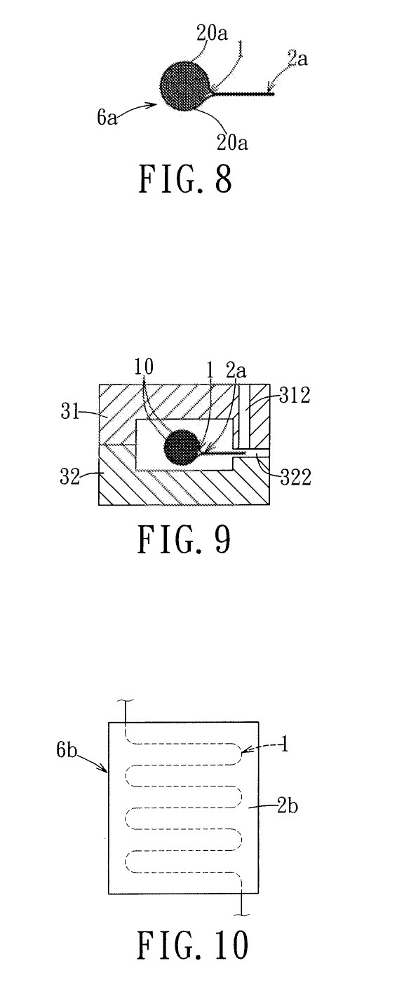

FIG. 8 illustrates the second preferred embodiment of a flexible electrothermal tape (6a) according to this invention, which is a modification of the first preferred embodiment. In this embodiment, the film member (2a) is configured as a unitary film body (2a) that is folded so as to form the film parts (20a). The flexible electrothermal tape (6a) can be manufactured by use of the lower and upper molds 32, 31 in the first preferred embodiment, as shown in FIG. 9.

FIG. 10 illustrates the third preferred embodiment of a flexible electrothermal tape (6b) according to this invention, which is modification of the first preferred embodiment. In this embodiment, the electrothermal wire 1 is folded to form a meandering shape. The film member (2b) is formed as a sheet. Therefore, during manufacture, it is required to select lower and upper molds (not shown) matching the shape of the film member (2b).

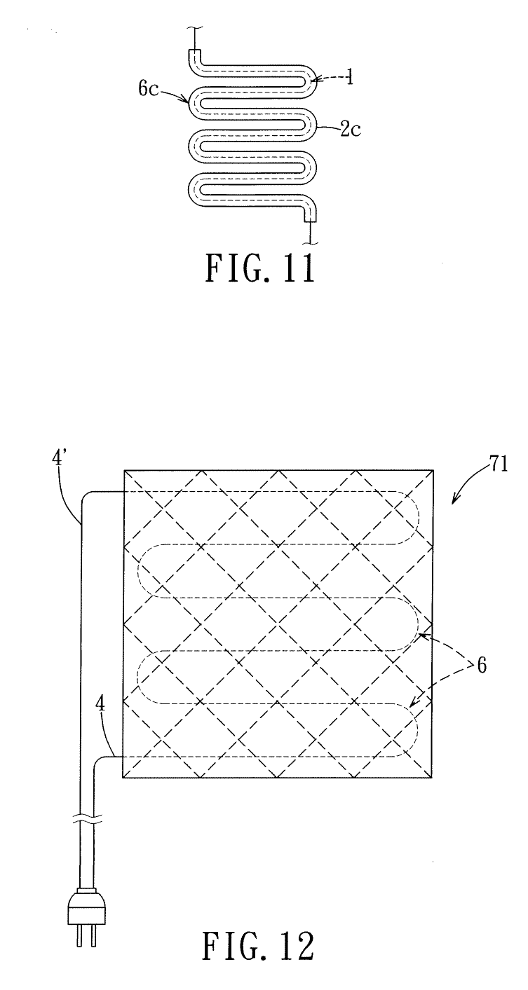

FIG. 11 illustrates the third preferred embodiment of a flexible electrothermal tape (6c) according to this invention, which is modification of the third preferred embodiment. In this embodiment, the film member (2c) is in the form of a meandering shape. Therefore, during manufacture, it is required to select lower and upper molds (not shown) matching the shape of the film member (2c).

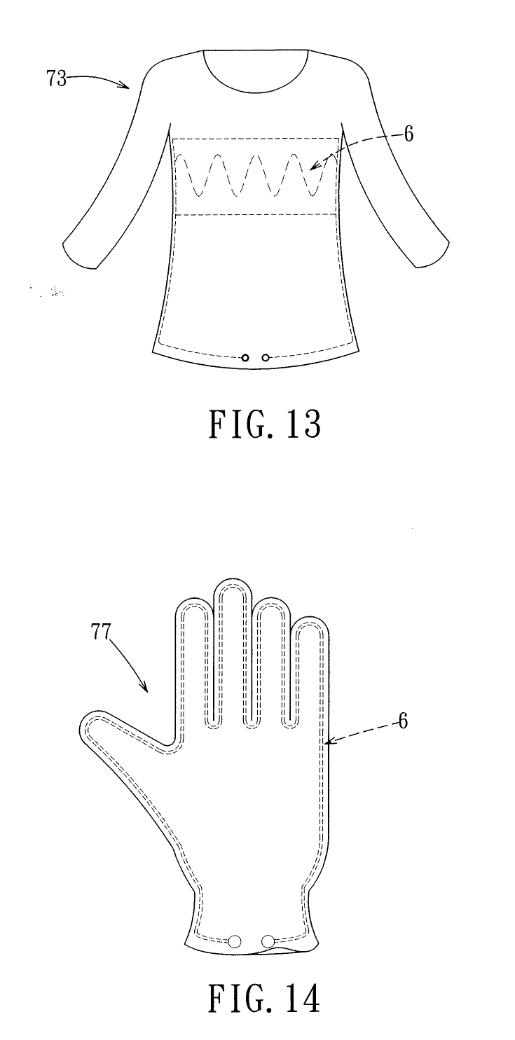

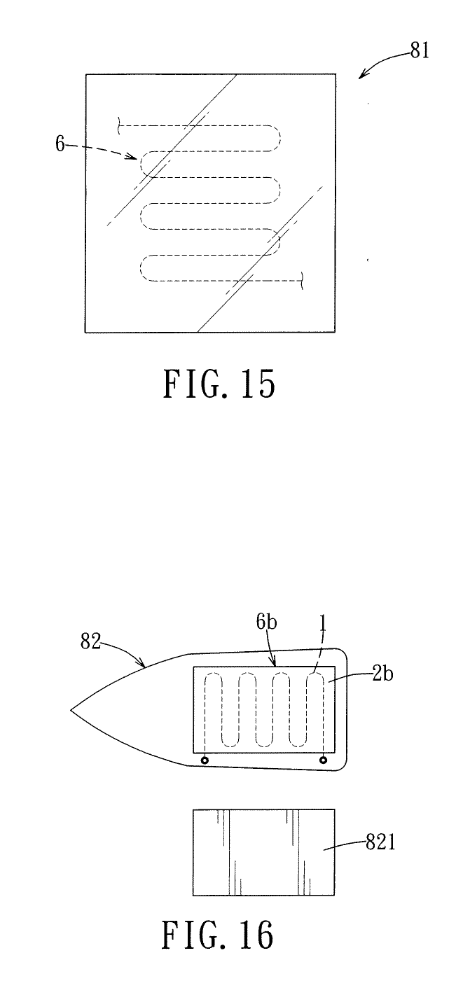

In sum, since the film member 2, (2a), (2b), (2c) can be formed as various shapes and can ensure a superior sealing effect, and since the electrothermal wire 1 can be designed to work at a temperature not greater than 200° C., the flexible electrothermal tape 6, (6a), (6b), (6c) of this invention can find various applications, such as to a thermal pad 71 shown in FIG. 12, clothing 73 shown in FIG. 13, a glove 77 shown in FIG. 14, an electrothermal stove 81 shown in FIG. 15, and an electric iron 82 shown in FIG. 16. In FIG. 16, since the film member (2b) of the flexible electrothermal tape (6b) is formed as a sheet, the flexible electrothermal tape (6b) can entirely contact a heat-conducting base 821 of the electric iron 82, thereby resulting in superior heat-conductivity. Furthermore, since the electrothermal wire 1 is easily folded to form a meandering shape, the heat-conducting base 821 of the electric iron 82 can be formed to have a relatively small area, thereby reducing the size of the electric iron 82.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A flexible electrothermal tape comprising:
an electrothermal wire having opposite ends;
first and second conductive wires, each of which has an end portion connected electrically to a corresponding one of said opposite ends of said electrothermal wire; and
a flexible film member enclosing sealingly said electrothermal wire and said end portions of said first and second conductive wires, said film member having a pair of film parts overlapping each other such that said electrothermal wire and said end portions of said first and second conductive wires are disposed between said film parts.

2. The flexible electrothermal tape as claimed in claim 1, wherein said film parts of said film member are interconnected and a vacuum is created therebetween.

3. The flexible electrothermal tape as claimed in claim 1, wherein said film member is made of a waterproof material.

4. The flexible electrothermal tape as claimed in claim 3, where the waterproof material includes polyimide.

5. The flexible electrothermal tape as claimed in claim 1, wherein said electrothermal wire includes a plurality of carbon fiber bundles.

6. The flexible electrothermal tape as claimed in claim 5, wherein each of said carbon fiber bundles of said electrothermal wire has opposite first and second ends, said first ends of said carbon fiber bundles being bundled by said end portion of said first conductive wire, said second ends of said carbon fiber bundles being bundled by said end portion of said second conductive wire.

7. The flexible electrothermal tape as claimed in claim 6, wherein:
said first ends of said carbon fiber bundles of said electrothermal wire are soldered to said end portion of said first conductive wire; and
said second ends of said carbon fiber bundles of said electrothermal wire are soldered to said end portion of said second conductive wire.

8. The flexible electrothermal tape as claimed in claim 6, wherein each of said first and second conductive wire includes a metal wire having a bundling end for bundling corresponding ones of said first and second ends of said carbon fiber bundles of said electrothermal wire, and an insulating sleeve sleeved on said metal wire such that said bundling end of said metal wire extends outwardly of said insulating sleeve.

9. The flexible electrothermal tape as claimed in claim 8, wherein:
said bundling end of said metal wire and a part of said insulating sleeve of said first conductive wire constitute said end portion of said first conductive wire, and are heat-sealed between said film parts of said film member; and
said bundling end of said metal wire and a part of said insulating sleeve of said second conductive wire constitute said end portion of said second conductive wire, and are heat-sealed between said film parts of said film member.

10. The flexible electrothermal tape as claimed in claim 1, wherein said film member is non-unitary, and includes two film bodies that serve as said film parts.

11. The flexible electrothermal tape as claimed in claim 1, wherein said film member is configured as a unitary film body that is folded so as to form said overlapping film parts.

12. A method for manufacturing a flexible electrothermal tape, comprising the steps of:
a) placing an electrothermal wire coupled electrically to and disposed between first and second conductive wires and enclosed by a flexible film member in a mold cavity of a lower mold, the electrothermal wire having opposite ends, each of which is connected electrically to an end portion of a corresponding one of the first and second conductive wires, the film member having a pair of film parts overlapping each other such that the electrothermal wire and the end portions of the first and second conductive wires are disposed between the film parts;
b) disposing an upper mold complementary to the lower mold on the lower mold such that each of the film parts has a peripheral portion clamped between the lower and upper molds, and such that the upper mold cooperates with the lower mold so as to define an air-extracting channel therebetween;
c) heat-sealing the peripheral portions of the film parts of the film member such that an inner space is formed between the film parts, an opening being formed between the peripheral portions of the film parts and being in spatial communication with the air-extracting channel in an assembly of the lower and upper molds;
d) extracting air from the inner space between the film parts via the opening and the air-extracting channel, and heat-sealing the opening so that the electrothermal wire interconnecting electrically the first and second conductive wires cooperates with the film member to constitute the flexible electrothermal tape; and
e) removing the flexible electrothermal tape from the upper and lower molds.
